(19) United States
(12) Patent Application Publication
(10) Pub. No.: US 2010/0226722 A1
(43) Pub. Date: Sep. 9, 2010

(54) Systems, Apparatuses and Processes Involved with Hydrating Particulate Material

(76) Inventor: Emmett M. Walker, Reynolds, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/705,992

(22) Filed: Feb. 16, 2010

Related U.S. Application Data
(60) Provisional application No. 61/157,330, filed on Mar. 4, 2009.

(51) Int. Cl. B09B 5/00; B01F 5/20

(52) U.S. Cl. 405/129.95; 366/137.1

(57) ABSTRACT

Systems, apparatuses and processes involved with hydrating particulate material are provided. A representative process includes: delivering a pressurized stream of dry particulate material; spreading the stream of dry particulate material outwardly from an axis; spraying a pressurized aqueous liquid into the spread dry particulate material such that the particulate material is hydrated; moving the hydrated particulate material along a helical path; increasing the velocity of the hydrated particulate material; and directing the hydrated particulate material to a depository. The pressurized aqueous liquid may include leachate collected from a landfill.

### CROSS REFERENCE TO RELATED APPLICATION

This utility application claims the benefit of and priority to U.S. Provisional Patent Application 61/157,330, filed on Mar. 4, 2009, which is incorporated by reference herein in its entirety.

### TECHNICAL FIELD

The present disclosure is generally related to the combining of particulate material and liquid.

### DESCRIPTION OF THE RELATED ART

Fly ash represents the major by-product of burning coal for power generation. It is collected by scrubbing the effluent gases from the combustion furnaces, and presents a significant disposal issue on account of its volume and composition, which includes significant amounts of inert silicaceous material as well as heavy metals that can be a major environmental hazard if inadequately contained or disposed of. The composition of fly ash is dependent on the type of coal burned, with bituminous coal fly ash comprising mainly silica and iron oxide, alumina, and varying amounts of carbon. Subbituminous coal fly ash, in comparison, has significantly greater silica and alumina content and lower iron oxide levels.

A proportion of fly ash waste generated by power plants is stabilized and incorporated into cement and concrete based products that provide little environmental damage. The bulk of fly ash, however, is deposited in landfill. The ash can be delivered to local landfill sites as a freely flowing pumped slurry, or transported as dry powder to distant sites. Due to the possible toxicity of fly ash, and especially the health hazards of fine ash having a high silica content, it is undesirable to deposit dry ash material directly into a landfill thereby creating uncontrolled wind dispersal of the light-weight substance. It is necessary, therefore, to moisten the ash for distribution at a landfill site.

Landfill sites provide a constant effluent stream known as leach out, or leachate, that is highly variable in composition depending on the nature of the material deposited in the landfill. The water content derives from rainwater passing through the fill, and from the decomposition chemically or microbially of the organic material in the waste. Typically, leachates include dissolved methane, carbon dioxide, organic acids, aldehydes, alcohols, and simple sugars derived from carbonaceous sources, as well as iron aluminum, zinc, and ammonia, heavy metals leached into the liquid due to the initial acidity of the leachate, PCB's, dioxanes and the like.

While older and poorly regulated landfills may discharge leachate into the surroundings where it can readily enter the groundwater, more typically the leachate is drained from the landfill and stored before treatment to reduce the environmental impact, especially to the water supply. There would be advantages, therefore, in being able to reuse the leachate for redeposit back into the landfill, reducing treatment costs.

### SUMMARY

Systems, apparatuses and processes involved with hydrating particulate material are provided. In this regard, an exemplary embodiment of a process comprises: delivering a pressurized stream of dry particulate material; spreading the stream of dry particulate material outwardly from an axis; spraying a pressurized aqueous liquid into the spread dry particulate material such that the particulate material is hydrated; moving the hydrated particulate material along a helical path; increasing the velocity of the hydrated particulate material; and directing the hydrated particulate material to a depository.

An exemplary embodiment of a particulate material hydrating apparatus comprises: a housing having a side wall with an upper end and a lower end, the housing defining, in series, an inlet, a hydration section, a mixing chamber and an accelerating chamber; the inlet being located at the upper end of the housing, the inlet being operative to admit a particulate material into the hydration section for movement through the housing; a conical spreader positioned within the housing and located toward the upper end of the hydration section in coaxial alignment with the inlet, the conical spreader being operative to spread particulate material received through the inlet outwardly therefrom; a first liquid spray nozzle with a nozzle outlet positioned within the hydration section such that the nozzle outlet is oriented between the conical spreader and the mixing chamber, the first liquid spray nozzle being operative to discharge a liquid spray toward the particulate material as the particulate material moves downstream from the conical spreader; a first vane positioned within the mixing chamber, the first vane being operative to impart a rotation to the particulate material after being hydrated as the hydrated particulate material moves downstream from the hydration section; the accelerating chamber being operative to increase flow velocity of the hydrated particulate material; and an outlet communicating with the accelerating chamber and being operative to deliver hydrated particulate material received from the accelerating chamber.

Another example of the process of hydrating a particulate material is collecting leachate from a landfill and using the leachate as or in a hydrating liquid for hydrating fly ash and similar particulate matter. The hydrated material may be deposited in a landfill, or re-deposited in the landfill from which the leachate was collected.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 schematically illustrates an embodiment of a system for the hydration of a dry particulate material.

FIG. 2 illustrates a vertical cross-sectional view of an embodiment of a hydration apparatus, where the apparatus is a single unit.

FIG. 3A illustrates a top view of an embodiment of the spreader cone in the plane 3A-3A of the hydration apparatus illustrated in FIG. 2.

FIG. 3B illustrates a top view of an embodiment of the spreader cone in the plane 3B-3B of the hydration apparatus illustrated in FIG. 2.

FIG. 4 illustrates an exploded view of a vertical section of an embodiment of a hydration apparatus, where the apparatus comprises separable sections.

FIG. 5 illustrates a vertical section of an embodiment of a hydration apparatus, where the apparatus comprises separable sections, where the sections are connected and secured by bolted flanges. Dashed arrows indicate the predicted path of the particulate material stream through the apparatus.

FIG. 6A illustrates a vertical section of an embodiment of an inlet cap.

FIG. 6B illustrates a cross-sectional view of an embodiment of the inlet cap.

FIG. 7 illustrates a top view of the upper surface of an embodiment of a hydration chamber, at plane position 7-7 of FIG. 5.

FIG. 8 illustrates a cross-sectional view in the plane 8-8 of an embodiment of a hydration chamber at plane position 8 of FIG. 5.

FIG. 9 illustrates a cross-sectional view cone in the plane 9-9 of an embodiment of a mixing chamber at plane position 9 of FIG. 5.

The details of some exemplary embodiments are set forth in the description below. Other features and/or advantages of the disclosure may be and/or may become apparent to one of skill in the art upon examination of the following description, drawings, examples and claims. It is intended that all such features and/or advantages be included within this description, be within the scope of the present disclosure, and be protected by the accompanying claims.

### DETAILED DESCRIPTION

Before several exemplary embodiments are described in greater detail, it is to be understood that this disclosure is not limited to the particular embodiments described, and as such may, of course, vary. It is also to be understood that the terminology used herein is for the purpose of describing particular embodiments only, and is not intended to be limiting, since the scope of the present disclosure will be limited only by the appended claims.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, the following terms have the meanings ascribed to them unless specified otherwise. In this disclosure, “comprises,” “comprising,” “containing” and “having” and the like can have the meaning ascribed to them in U.S. patent law and can mean “includes,” “including,” and the like; “consisting essentially of” or “consists essentially” or the like. “Consisting essentially of” or “consists essentially” or the like, when applied to process and compositions encompassed by the present disclosure have the meaning ascribed in U.S. patent law and the term is open-ended, allowing for the presence of more than that which is recited so long as basic or novel characteristics of that which is recited is not changed by the presence of more than that which is recited, but excludes prior art embodiments.

It should be emphasized that the embodiments of the present disclosure, particularly, any “preferred” embodiments, are merely possible examples of the implementations, merely set forth for a clear understanding of the principles of the disclosure. Many variations and modifications may be made to the described embodiments without departing substantially from the spirit and principles of the disclosure. All such modifications and variations are intended to be included herein within the scope of this disclosure and protected by the following claims.

The present disclosure provides systems, apparatuses and processes involved with hydrating particulate material. In some embodiments, the particulate material, flowing in a gas stream, is combined with a liquid, whereby the liquid may contact and coat the particles to increase their density and to promote aggregation into larger bodies. Dispersal of the hydrated and/or aggregated particles results in reduced fine particle dispersion that may represent a hazard to operators or the environment. In some embodiments, the hydration of the fine particulate material known as fly ash that is a by-product of the process for burning coal for energy can be accomplished.

Briefly described, embodiments of this disclosure, among others, encompass an apparatus for the hydration of high volumes of pressurized dry finely powdered materials. In an exemplary apparatus, hydration is achieved by passing a pressurized stream of dry powdered or particulate material through a liquid spray and through a mixing chamber that imparts a vortex motion to the stream, ensuring adequate mixing of the liquid and the particles. The product that exits the hydration apparatus has increased density due to hydration and aggregation of the fine particulate material, and resists uncontrolled dispersal when deposited onto a site such as a landfill.

An exemplary embodiment of a system for hydration of a particulate material comprises a system for delivery of the fine dry particulate material under pressure to a hydration apparatus, a source of a pressurized aqueous liquid deliverable to the hydration apparatus, and the hydration apparatus. In some embodiments, such a system may further comprise a depositor for receiving the hydrated material for storage or transport to a site distant from the hydrating apparatus.

Another embodiment involves a hydrating apparatus for mixing a dry particulate material with a liquid, preferably a liquid having flow characteristics similar to water, to generate a moist product that may be dispersed in a controlled manner, but which does not flow freely such as in a stream of liquid. In some embodiments, the hydrating apparatus comprises a spreader to ensure that the incoming particulate material is well distributed in a thinner stream throughout the apparatus, liquid spray nozzles for delivering the aqueous liquid into the thin particulate stream, and a mixing mechanism that generates a rotary motion to the particulate material and the liquid spray to ensure thorough mixing and moistening of the material. The flow rates of the particulate material and the liquid spray may be adjusted to provide a moist aggregated product substantially free of dry powder or free liquid.

Various ones of the systems, apparatuses and processes may be used to moisten, for example, fly ash for deposit in a landfill in a controlled manner. However, such may be readily adapted for use with other dry powder material and liquid.

In some embodiments, the spreading of the particulate material prior to the wetting of the particulate material assures wetting a greater volume of the particulate material prior to the following steps of the process.

In some embodiments, the lack of moving components ensures a lengthy service life with minimal maintenance other than simple cleaning. By regulating the flows of the input particulate material and the liquid flow, the moisture content of the output product may be adjusted to the requirements of the operator. Because of the pressurized nature of the input and output streams, the moistened product may be ejected for direct deposit at a selected site, or delivered to a transport container for delivery to the final site.

An exemplary embodiment of a particulate material hydrating apparatus for the hydration of bulk quantities of a dry particulate material, and which provides a hydrated mass that is not readily and undesirably dispersed in an uncontrolled manner will now be described in greater detail. The low density of many powders, such as, for example talc, china clay, fly ash and the like results in a high tendency to be dispersed inadvertently. With particulate material such as fly ash, which may include high levels of environmentally undesirable contaminants, disposal processes should keep uncontrolled spread and dispersal by such as wind to a minimum.

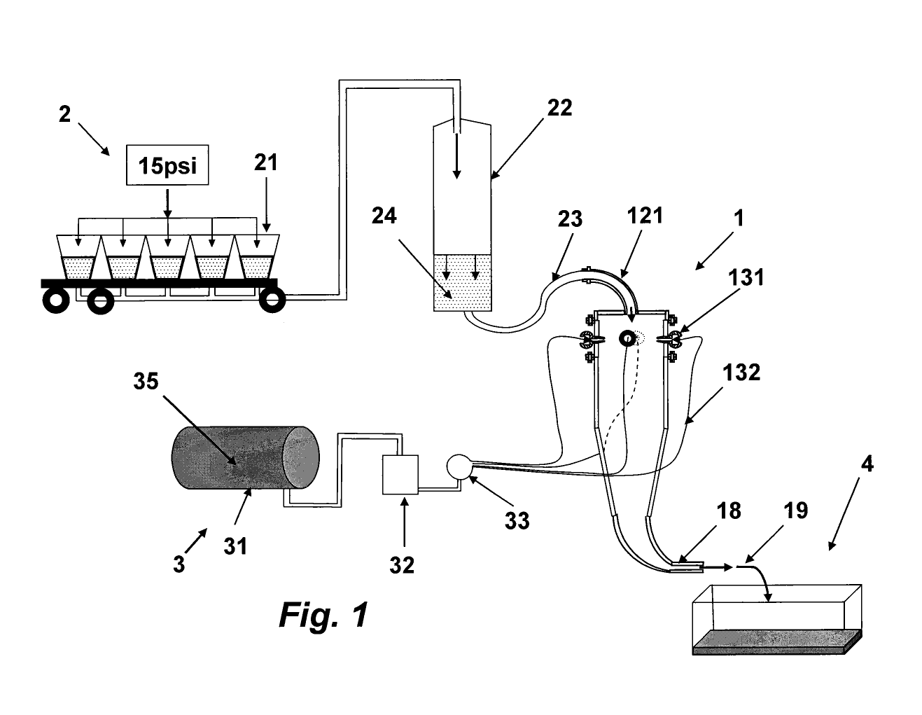

Material such as fly ash is most economically transported from a site of generation, such a coal-fired power plant to a landfill or other disposal site, as a dry powder and not in a bulkier and heavier hydrated form that would otherwise increase transport costs. An exemplary embodiment of a hydrating apparatus provides a means of hydrating a dry particulate material to a dampness level that increases the density for controlled dispersal, while not so wet or hydrated that undesirable levels of water are consumed that may damage a landfill or lead to excessive levels of contaminating leach out (“leachate”) from a landfill. A desirable level of hydration of fly ash, for example, may produce a product that may retain shape when compressed, but still have a particulate composition similar to that of dampened sand. The exemplary embodiment of hydrating apparatus (i.e., apparatus 1 of FIG. 1), therefore, mixes an incoming particulate stream with a corresponding flow of an aqueous liquid in a constant flow that may be discharged as a pressurized stream into a suitable depository, or immediately discharged to a site such as a landfill.

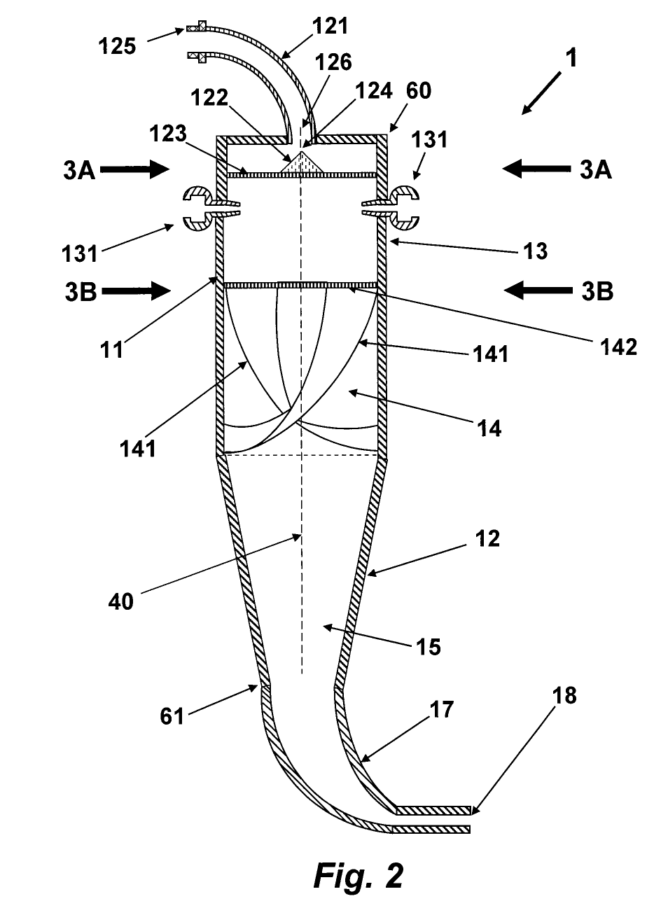

FIG. 1 illustrates an exemplary embodiment of a system for the hydration of a dry particulate material, with FIG. 2 showing the hydrating apparatus 1 in greater detail. Hydrating apparatus 1 comprises a housing 11 (e.g., a tubular housing) defining in longitudinal series a particulate matter hydration section 13, a mixing chamber 14, and an accelerating chamber 15. The housing includes an upwardly extending longitudinal axis 40, a side wall 12, an upper end 60 and a lower end 61.

A particulate material delivery inlet 121 is located at the upper end 60 of the housing 11 for admitting a particulate material into the hydration section 13 for movement downwardly through the housing 11. In this embodiment, the inlet 121 includes a locking feature 125 (e.g., a flanged fitting) for securely attaching the delivery pipe 23 shown in FIG. 1 to the inlet 121 for the pressurized delivery of a particulate material to the hydrating apparatus 1.

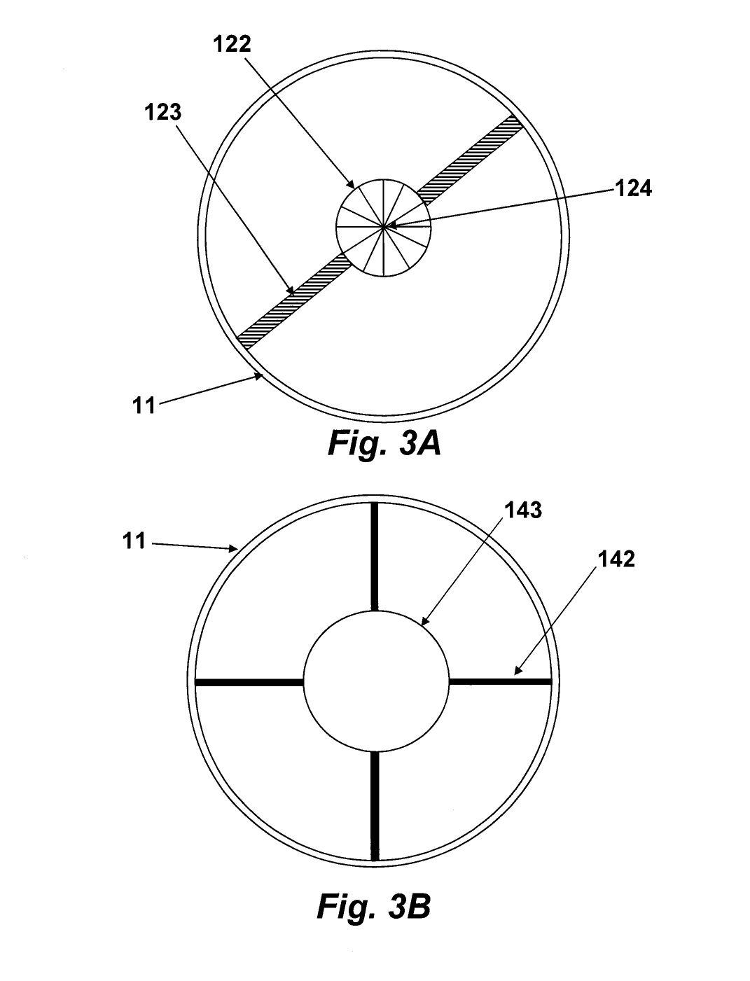

A material spreader 122 (such as a conical spreader of FIG. 2) is located towards the upper end of the hydrating section, with the apex 124 of the spreader directed toward, and in coaxial alignment with, the inlet port 126 of the inlet 121. It is contemplated that the spreader 122 may be of a conical form, including a simple cone, a fluted cone, or a ribbed cone, and other shapes configured for spreading the particulate material received through the particulate material delivery inlet 121 outwardly within the hydration section towards the side wall 12 of the housing 11. The diverging shape of the spreader forms the particulate material in a thinner veil at the entrance of the mixing chamber and adjacent the side wall of the mixing chamber. As shown in FIG. 3A, for example, the spreader 122 may be secured in position by a traversing cross-member 123.

At least one liquid spray nozzle 131 traverses the side wall 12 such that at least the outlet of the nozzle extends through the side wall of the housing, with the nozzle being preferably located below the spreader 122 and above the mixing chamber 14. Nozzle 131 is directed so as to discharge a liquid spray towards the longitudinal axis 40 of the housing 11. As shown in FIG. 1, the nozzle is further configured (such as by incorporating a locking device) for securely attaching a pressure liquid delivery hose 132 to the nozzle 131 for delivering a pressurized aqueous liquid to the nozzle.

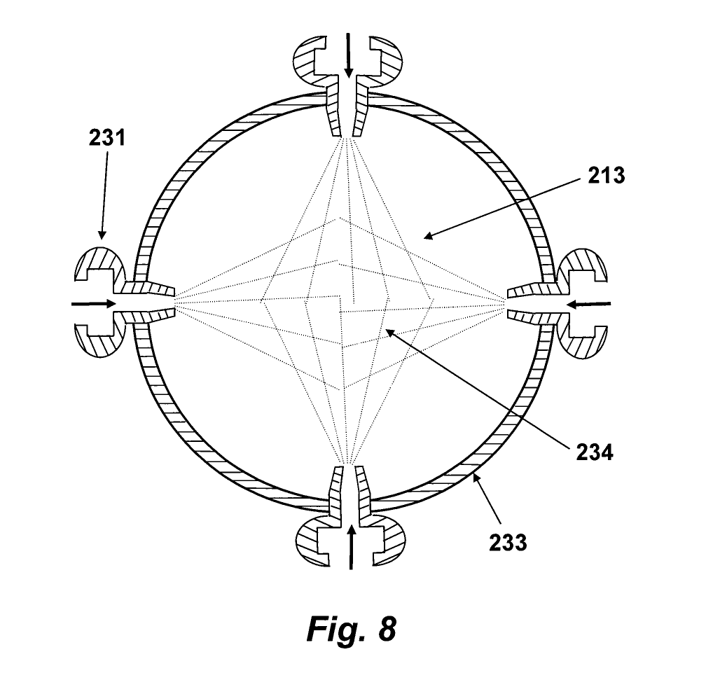

It is further contemplated that a preferred configuration of the hydration chamber 13 may include a plurality of spray nozzles 131, such as four nozzles, each of which is directed toward the axis 40, thereby generating a multiple spray pattern that can provide significant coverage of the cross-section of the tubular housing 11, as shown, for example, in FIG. 8. The nozzles 131 may be configured to provide any desirable spray pattern, although to achieve substantial coverage of a cross-section of the hydration chamber 13, a preferred pattern is a fan-shape spray. The spray pattern is, therefore, directed toward the particulate material as the particulate material moves away from the spreader 122 and past the spray nozzles 131.

As shown in FIG. 2, at least one arcuate elongated mixing vane 141 is positioned within the mixing chamber 14 that is configured to impart a rotation to the hydrated particulate material stream as the stream moves downwardly from the hydration section 13 and through the mixing chamber 14. In an exemplary embodiment, the mixing chamber includes a plurality of elongated vanes 141, as shown in the vertical section of FIG. 2, where two vanes are illustrated. In another embodiment, there may be three or four vanes 141, where the upper end of each vane 141 is radially offset from its neighbor, such as an offset of about 90°.

Vanes 141 of the depicted embodiment are attached at their lower ends to the side wall 12 of the housing 11. The opposite, or upper, end of the elongated vanes 141 are attached to a cross-member 142 that, in this embodiment, extends from the side wall 12 radially inwardly toward the longitudinal axis of the mixing chamber 14. FIG. 3B, for example, illustrates in plan view cross-members 142, attached to a hub 143, that accommodate the upper ends of four elongated vanes 141.

Immediately below, and in communication with the mixing chamber 14, is accelerating chamber 15, which is defined by a converging side wall of the housing 11. Accelerating chamber 15 is operative to increase the flow velocity of the hydrated particulate material descending from the mixing chamber 14.

Downstream of the accelerating chamber 15, the hydrating apparatus 1 further comprises an output tube 17 that is attached to the lower end 61 of the housing 11. In the embodiment depicted in FIG. 2, outlet tube 17 exhibits a decreasing cross-sectional area in the flow direction and includes an outlet port 18 for the discharge of the hydrated particulate material from the hydrating apparatus 1. Notably, in this embodiment, outlet tube 17 directs the flow of hydrated particulate material away from the longitudinal axis 40.

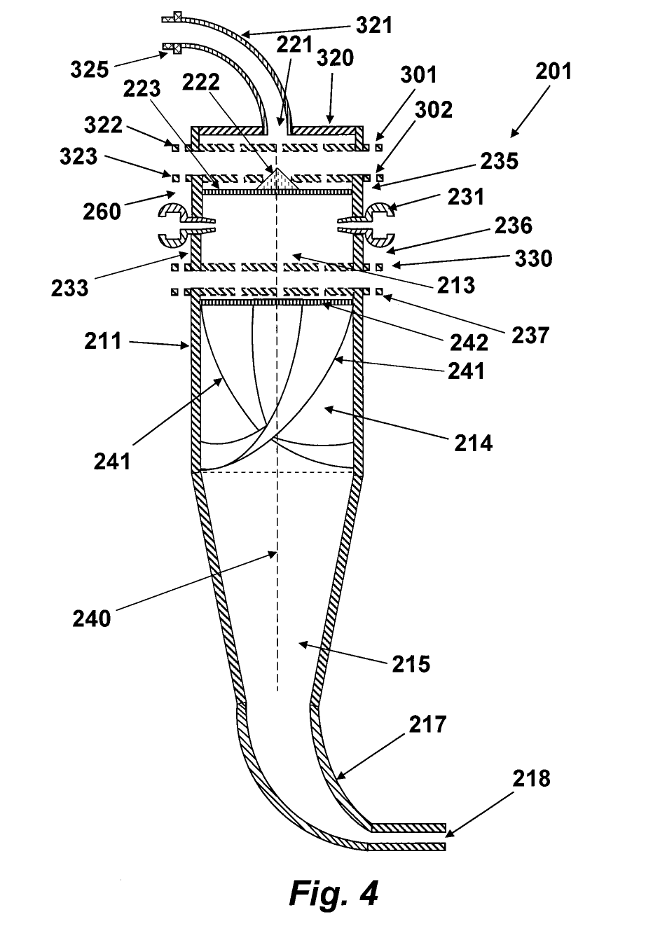

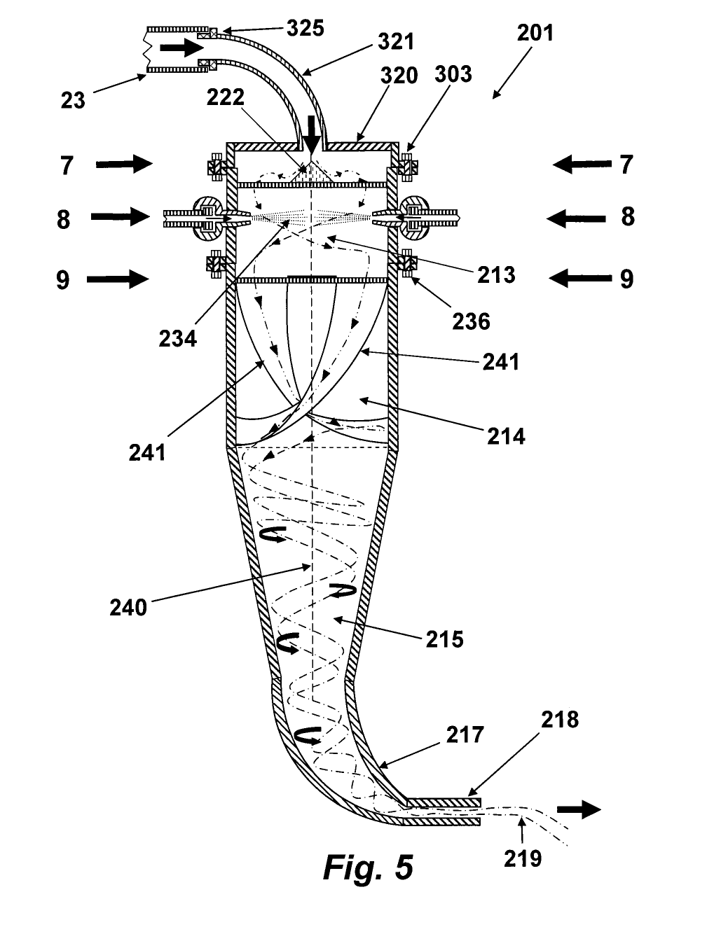

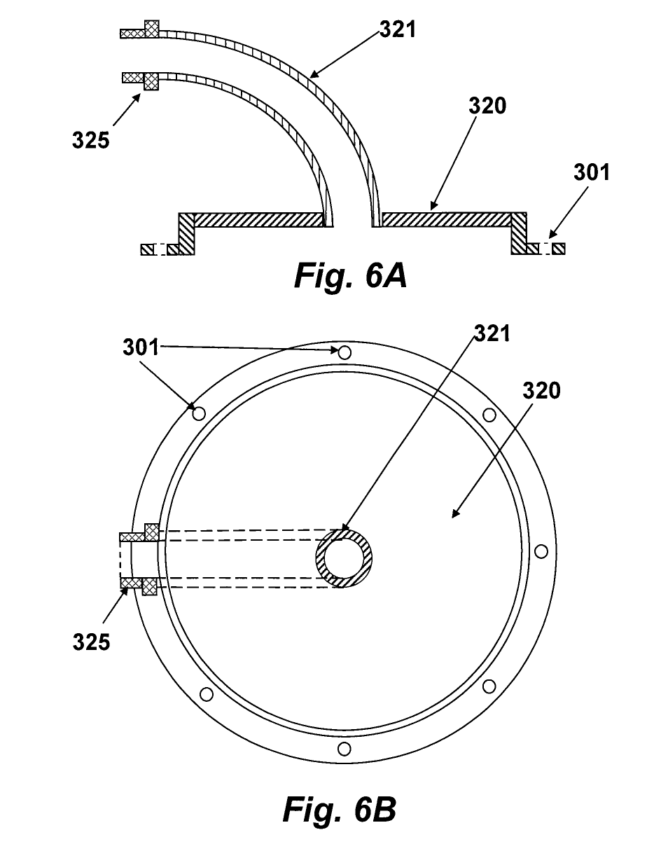

Referring now to FIGS. 4-9, while it is contemplated that a hydrating apparatus may be constructed as a single unit (as shown for example in FIG. 2), it is further contemplated that other embodiments of the hydrating apparatus may be constructed in sections that may be assembled for operation, and then disassembled for ease of manufacture, transport, cleaning, inspection and/or maintenance. Accordingly, the embodiment as shown in FIGS. 4 and 5 may be in disassembled form, as shown in FIG. 4, and in operational assembled form, as illustrated in FIG. 5.

As illustrated in the exploded view of FIG. 4, for example, the hydration apparatus 201 comprises a housing 211 and an outlet tube 217. The housing 211 comprises a particulate material inlet cap 320, a particulate hydration section 213, a mixing chamber 214, and an accelerating chamber 215. The particulate material inlet cap 320 comprises an inlet 321 and a locking feature 325 configured to engage and secure a delivery pipe for supplying a pressurized particulate material to the housing. The inlet cap 320 further comprises a first connecting flange 322 for securing the inlet cap to a second flange 323 positioned at the upper end 260 of the hydration section 213. The connecting flange 322 includes a plurality of traversing holes 301 that are coaxially aligned with similar holes 302 in the second flange 323, thereby allowing securing bolts 303 to secure the inlet cap 320 to the housing 211 (FIG. 5). It is contemplated that there may be a gasket (not shown) between the flanges 322 and 323 to improve the sealing between the inlet cap and housing.

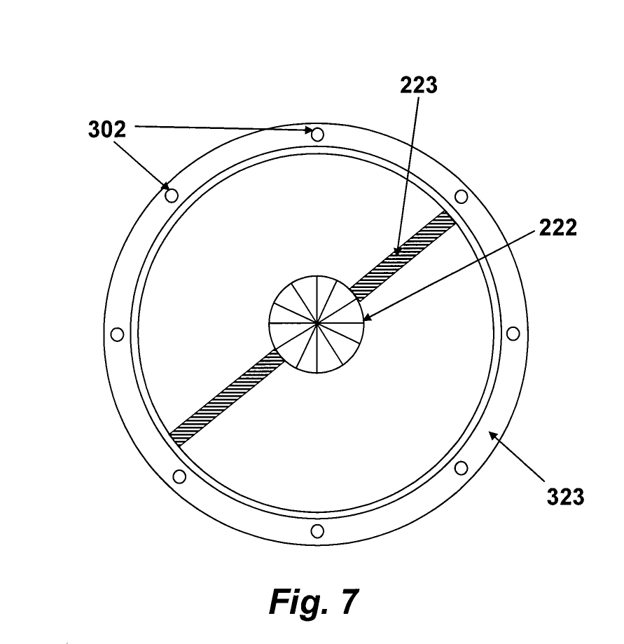

In this embodiment, the hydration section 213 comprises a cylindrical side-wall 233 that extends between an upper end 235 and a lower end 236. A conical spreader 222 is positioned at the upper end 235 of the hydration section, and is coaxially aligned with inlet delivery port 221. As shown in FIG. 7, conical spreader 222 of this embodiment is secured in position by a traversing cross-member 223.

At least one liquid spray nozzle 231 traverses the side wall 233 of the hydration section, and is oriented to deliver a pressurized liquid spray towards the longitudinal axis 240 of the housing 211. The at least one liquid spray nozzle 231 is configured to securely engage with a delivery tube for delivering a pressurized aqueous liquid to the spray nozzle 231. A preferred configuration includes four spray nozzles 231, each of which directs a spray of liquid towards the axis 240, thereby generating a four spray pattern that can provide significant coverage of the cross-section of the housing, as shown, for example in FIG. 8.

A third flange 330 disposed at the lower end 236 of the hydration section 213 is configured for securing to a fourth flange 237 of the mixing chamber 214. In this embodiment, bolts (e.g., bolts 236 of FIG. 5) are used to fasten the flanges 330 and 237 together.

As shown in FIG. 5, mixing chamber 214 includes at least one elongated vane 241, with the at least one vane being configured to impart a rotation to the hydrated particulate material stream as the stream (depicted with dashed and arrowed lines) moves downwardly from the hydration section 213 and through the mixing chamber 214. In the embodiment of FIGS. 4 and 5, two such vanes are illustrated.

Accelerating chamber 215, defined by a converging conical side wall of the housing, is positioned downstream of the mixing chamber 214. Accelerating chamber 215 is operative to increase the flow velocity of the hydrated particulate material descending from the mixing chamber 214.

An output tube 217 is attached to the lower end 261 of the housing 11, and includes an outlet 218 for discharging the hydrated particulate material 219 from the apparatus.

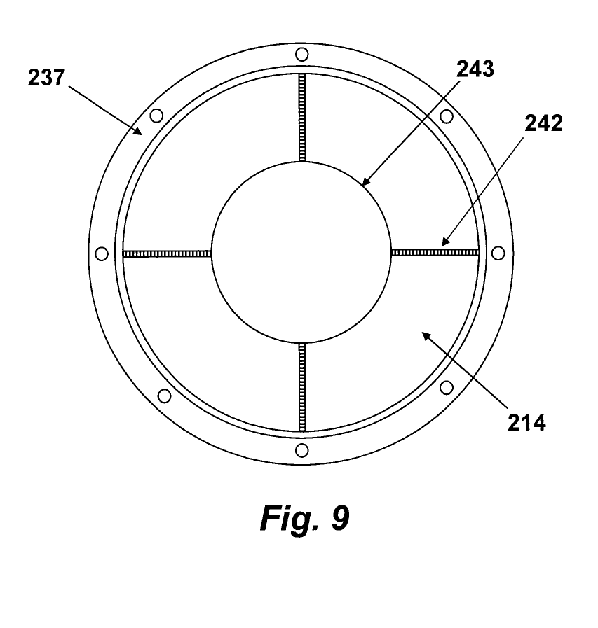

FIG. 9 illustrates a plan view of cross-members 242, attached to a hub 243, that accommodate the upper ends of four elongated vanes 241.

A hydrating apparatus may be constructed of any material able to withstand the abrasive action of the input pressurized particulate material stream, and of the material as it passes through the apparatus. It is contemplated that the conical spreader, the elongated vanes and the outlet may be subjected to significant abrasion. Accordingly, when the particulate material is a mineral such as fly ash, pumice, kaolin or the like, the apparatus is preferably constructed of a material such as, but not limited to, steel, hardened steel, stainless steel, ceramic coated steel, and the like. If the particulate material is soft, such as a talc or an organic or food product, it is contemplated that the hydration apparatus alternatively may be made of material such as a plastic that is able to withstand the pressure and abrasion that even these softer materials may impart to the apparatus. In addition to resistance to wear, the walls of the housing should be sufficiently thick to withstand the internal pressure (e.g., at least about 15 psi) during the operation of the hydration apparatus.

Another aspect of the present disclosure encompasses an integrated system for the delivery, hydration, and disposal of a hydrated particulate material. Referring now to FIG. 1, an exemplary embodiment of such a system comprises a hydration apparatus 1 operably connected to an aqueous liquid delivery system 3 for delivering a pressurized aqueous liquid 34 to spray nozzles 131 of the hydrating apparatus 1, and a particulate material delivery system 2 operably connected to hydrating apparatus 1 for delivering a pressurized stream of dry particulate material 24 thereto.

The particulate material delivery system 2 can be any assemblage of components that can supply a dry stream of particulate material 24 to the inlet 121 of the hydrating apparatus 1. For example, but not limiting, the particulate material delivery system 2 may comprise a hopper vehicle 21 capable of being pressurized to withstand pressure of at least 15 psi, and a pressure hose for delivery of the material 24 to a separate storage container 22 or, optionally, directly communicating with the inlet 121 of the hydrating apparatus 1. It is anticipated that pressure may be applied to the top of the particulate material 24 while in a vehicle hopper 21, but that the material 24 may exit the hopper from below. Such systems are well known and may be found on road and rail vehicles used for transport of particulate material. Depending on the amount of particulate material 24 that is to be hydrated, it may be advantageous to deliver the material 24 from the delivery vehicle 21 to a pressurized storage container 22 (e.g., a silo) operably connected to the inlet 121 of the hydrating apparatus 1.

In operation, top pressure may applied to the particulate material contents of the delivery vehicle 21, and/or the receiving storage container 22 to force said contents along a pressure hose securely attached to inlet 121 of the hydrating apparatus 1. One suitable applied pressure has been found to be about 15 psi, although it is contemplated that this pressure may be varied depending on the nature (density, dryness, etc) or volume of the particulate material 24 to be hydrated.

The system depicted in FIG. 1 further comprises an aqueous liquid delivery system 3, comprising a source 31 of an aqueous liquid 35 operably connected to a pump 33 for delivering the liquid to a spray nozzle 131 of the hydrating apparatus 1. To prevent undesirable blockage of the spray nozzle 131, it may be advantageous to provide a strainer 32 to remove solid matter from the aqueous liquid 35. A strainer may be placed between the liquid source 31 and the pump 33, as shown in FIG. 1, or between the pump 33 and the hydrating apparatus. If the hydrating apparatus 1 is provided with more than one spray nozzle 131, as shown in FIG. 1, the pump 33 of the system may discharge the pressurized liquid into a manifold to which are connected liquid delivery hoses 132 securely attached to the spray nozzles 131 of the hydrating apparatus 1. Alternatively, the delivery hoses 132 may individually be connected to the pump 33 outlet. If only one spray nozzle 131 is used, the delivery hose thereof may be connected directly to the pump 33 outlet.

The outlet 18 of the hydrating apparatus 1 may be directed to deliver a stream of hydrated particulate material 19 to a depository 4. The depository 4 for use in the system of the disclosure may be, but is not limited to, a trench in the ground, a receiving tank, or a receiving delivery vehicle for removal of the hydrated material to a distant location. Alternatively, the pressurized stream may be directed to spread to an area immediately adjacent the hydrating apparatus.

One example of the use of a particulate material hydrating system is the hydration of fly ash delivered from a coal-fired power plant for disposal in a landfill. The material may be transported as a dry powder in, for example, railroad bulk powder trucks holding about 40 tons of material each. The railroad trucks may be brought close to the hydrating apparatus, connected to a storage container or directly to the hydrating apparatus, and pressurized to discharge the dry material. Alternatively, the material may be off-loaded from the railroad vehicles to road hopper trucks for delivery of the particulate material to the site of hydration.

When provided to the hydrating apparatus 1, the fly ash may be pressurized by top pressure, and the material flows as a stream into the hydrating apparatus 1. The amount of material treated per minute will depend on the pressure applied and the physical characteristics of the particles, and the size of the delivery conduits. The dimensions of the hydrating apparatus 1 may be selected according to the amount of material required to be hydrated. A useful top pressure applied to the bulk particulate material has been found to be about 15 psi.

In operation, it is preferred that the aqueous liquid supply to the spray nozzles 131 of the hydrating apparatus 1 be engaged before delivery of the dry particulate material. When the applied top pressure of the incoming particulate material is about 15 psi, a useful liquid pressure has been found to be about 60 psi. However, it is anticipated that the liquid pressure, and the particulate matter flow rates, will be adjusted to achieve a desired degree of hydration of the material. The quality of the hydration of the particulate material may be judged, for example, by observing the output 19 from the hydrating apparatus 1. If there is insufficient hydration, due to an excessive top pressure in the material storage container 22, or too low liquid flow rate, this may be observed as dry particulate material blowing from the outlet 18, in which case the liquid flow rate may be increased. Alternatively, fluid discharging from the outlet 18 will indicate that the spray liquid flow was too great for the particulate flow applied, and the liquid flow rate may be reduced accordingly. It is anticipated that it is more convenient for the system operator to regulate the flow of liquid 35 to the spray nozzles 131, than to reduce or increase the top pressure to the particulate material in the storage container or the delivery vehicles.

An embodiment of a hydration apparatus may be useful for hydrating a particulate material to produce an aggregated material with sufficient moisture content to increase the density of the material, resulting in aggregation of the particles, and thereby allowing distribution of the material without undesirable dispersal in an uncontrolled manner, as is the case with dry powdered particulate material. Accordingly, an exemplary embodiment of a process of hydrating a particulate material, comprises the steps of: (i) delivering a pressurized stream of dry particulate material into a mixing chamber (e.g., by passing the material through a particulate matter inlet port); (ii) spreading the stream of dry particulate material outwardly (e.g., radially outwardly from a longitudinal axis of the mixing chamber) within the mixing chamber; (iii) spraying a pressurized aqueous liquid into the spread dry particulate material in the mixing chamber, whereby the particulate material is hydrated; (iv) moving the hydrated particulate material along a helical path within the mixing chamber; (v) moving the hydrated particulate material from the mixing chamber (e.g., through an accelerating chamber) to increase the velocity of the particulate material and the liquid; and (vi) directing the hydrated particulate material to a depository.

In some embodiments, the step of directing the hydrated particulate material to the depository may comprise directing a stream of the hydrated particulate material through the air to a landfill.

In some embodiments, the process involves an embodiment of a hydration apparatus (such as an embodiment depicted herein). In such an embodiment, the step of spreading the stream of particulate material outwardly within the mixing chamber may comprise directing the particulate material delivered from the particulate matter inlet of the hydration apparatus toward the apex of a conical spreader. The incoming material is distributed radially outwards toward the walls of the apparatus, downwardly through the hydration chamber, and into a spray of aqueous liquid.

In some embodiments, the step of spraying a pressurized aqueous liquid into the spread particulate material in the mixing chamber may comprise directing the liquid into the particulate material as the particulate material is being spread by a conical spreader.

To deliver the dry particulate material from the delivery system 2 to the hydration apparatus 1, it may be advantageous to apply a pressure to the top of the hoppered or siloed material. Since the material, before entering the apparatus will preferably be in a dry state and of fine particle size, the material should be free-flowing and therefore exit the delivery system as a pressurized stream. In some embodiments of the process, therefore, a desired pressure of the particulate material, as it enters the hydration apparatus is between about 10 psi and about 20 psi. This pressure to be applied, however, should be sufficient to force hydrated material, formed after passage through the spray system of the hydrating apparatus, to exit from the apparatus as a pressurized stream. In some embodiments, the pressure of the stream and of the top pressure applied to the stored dried material is about 15 psi.

In some embodiments, the pressure of the aqueous liquid delivered to the at least one liquid spray nozzle is adjusted whereby the hydrated particulate material is delivered from the hydrating apparatus in a gas/hydrated particulate material stream.

The process may be applied to other dry particulate materials, but the process is particularly useful for the hydration of dry fly ash before depositing in a landfill. Fly ash is one of the residues generated in the combustion of coal and is generally captured from the chimneys of coal-fired power plants. Depending upon the source and makeup of the coal being burned, the components of fly ash vary considerably, but all fly ash usually includes substantial amounts of silicon dioxide (SiO₂) (both amorphous and crystalline) and calcium oxide (CaO). Toxic constituents usually include heavy metals such as arsenic, beryllium, boron, cadmium, chromium, chromium VI, cobalt, lead, manganese, mercury, molybdenum, selenium, strontium, thallium, and vanadium, along with toxic organic substances such as dioxins and PAH compounds.

In the U.S.A., fly ash is generally stored at coal power plants or placed in landfills while about 43 percent is recycled, by use as supplements to Portland cement in concrete production, or is used in the synthesis of geopolymers and zeolites.

Fly ash particles are generally spherical in shape and range in size from 0.5 μm to 100 μm. They consist mostly of silicon dioxide (SiO₂), which is present in two forms: amorphous, which is rounded and smooth, and crystalline, which is sharp, pointed and hazardous; aluminum oxide (Al₂O₃) and iron oxide (Fe₂O₃). Fly ashes are generally highly heterogeneous, consisting of a mixture of glassy particles with various identifiable crystalline phases such as quartz, mullite, and various iron oxides.

Where fly ash is stored in bulk, it is usually stored wet rather than dry, so as to control a dust hazard. These impoundments are typically large and stable for long periods, but any breach of their dams or bunding will be rapid and on a massive scale.

It is, however, further considered within the scope of the present disclosure for the process of hydration (such as those using a disclosed apparatus) to be applicable to any fine (about 0.5 μm to about 100 μm) particulate material that needs to be hydrated. Such particulate material includes, but is not limited to, fly ash, kaolin (china clay), pumice, and the like.

It is further contemplated that such a process may incorporate the use of any aqueous liquid. A particularly advantageous aqueous liquid for use in the process of the disclosure is landfill leachate. This liquid is the result of decomposition within a landfill and leaching of rainwater through the fill, and collects and comprises ammonia, refuse and microbial breakdown products and any other water-soluble compounds deposited in the landfill or produced therein. Accordingly, use may be made of the contaminated water supply usually present at a landfill, and which may be combined with such as fly ash that is to be deposited on the landfill.

It should be emphasized that the embodiments of the present disclosure, particularly, any “preferred” embodiments, are merely possible examples of the implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure, and the present disclosure and protected by the following claims.

We claim:

1. A particulate material hydrating apparatus, comprising:
a housing having a side wall with an upper end and a lower end, the housing defining, in series, an inlet, a hydration section, a mixing chamber and an accelerating chamber;
the inlet being located at the upper end of the housing, the inlet being operative to admit a particulate material into the hydration section for movement through the housing;
a conical spreader positioned within the housing and located toward the upper end of the hydration section in coaxial alignment with the inlet, the conical spreader being operative to spread particulate material received through the inlet outwardly therefrom;
a first liquid spray nozzle with a nozzle outlet positioned within the hydration section such that the nozzle outlet is oriented between the conical spreader and the mixing chamber, the first liquid spray nozzle being operative to discharge a liquid spray toward the particulate material as the particulate material moves downstream from the conical spreader;
a first vane positioned within the mixing chamber, the first vane being operative to impart a rotation to the particulate material after being hydrated as the hydrated particulate material moves downstream from the hydration section;
the accelerating chamber being operative to increase flow velocity of the hydrated particulate material; and
an outlet communicating with the accelerating chamber and being operative to deliver hydrated particulate material received from the accelerating chamber.

2. The particulate material hydrating apparatus of claim 1, wherein:
the apparatus further comprises an inlet cap extending across and covering the upper end of the housing, the inlet cap having a first flange extending about the periphery thereof and the inlet; and
the upper end of the housing has a second flange extending about the periphery thereof such that fastening the first flange to the second flange secures the inlet cap to the hydration section.

3. The particulate material hydrating apparatus of claim 1, wherein:
the hydration section has a third flange positioned at a lower end thereof; and
the mixing chamber has a fourth flange positioned at an upper end thereof such that fastening the third flange to the fourth flange secures the hydration section to the mixing chamber.

4. The particulate material hydrating apparatus of claim 1, wherein:
the first vane is an elongate vane extending between a first end and a second end;
the apparatus further comprises a first cross-member extending at least partially across the upper end of the mixing chamber; and
the first end of the first vane is attached to the first cross-member.

5. The particulate material hydrating apparatus of claim 1, wherein, with respect to a downstream flow direction, side walls of the accelerating chamber exhibit a converging configuration.

6. The particulate material hydrating apparatus of claim 1, wherein:
the first liquid spray nozzle is one of four liquid spray nozzles of the apparatus arranged in opposing pairs of the nozzles and oriented in a planar configuration; and
four liquid spray nozzles are operative to spray pressurized liquid towards a longitudinal axis of the hydration section.

7. A system for hydrating a particulate material, the system comprising a particulate hydrating apparatus according to claim 1 and further comprising an aqueous liquid delivery system operative to deliver a pressurized aqueous liquid to the first liquid spray nozzle of the hydrating apparatus.

8. The system according to claim 7, wherein the aqueous liquid delivery system comprises a source of the aqueous liquid and a pump operative to deliver the liquid to the first liquid spray nozzle.

9. The system according to claim 8, wherein the aqueous liquid delivery system further comprises a strainer operative to strain the aqueous liquid before delivery of the first liquid spray nozzle.

10. The system according to claim 7, further comprising a particulate material delivery system operative to deliver a pressurized stream of the particulate material to the hydration section of the hydrating apparatus.

11. The system according to claim 10, wherein the particulate material delivery system comprises a pressurized particulate material container operative to store particulate material prior to the particulate material being delivered to the hydrating section of the hydrating apparatus.

12. The system according to claim 7, further comprising a depository operative to receive hydrated particulate material provided from the hydrating apparatus.

13. A process for hydrating a particulate material, comprising:
delivering a pressurized stream of dry particulate material;
spreading the stream of dry particulate material outwardly from an axis;
spraying a pressurized aqueous liquid into the spread dry particulate material such that the particulate material is hydrated;
moving the hydrated particulate material along a helical path;
increasing the velocity of the hydrated particulate material; and
directing the hydrated particulate material to a depository.

14. The process according to claim 13, and further including the step of collecting leachate from a landfill, and wherein the step of spaying a pressurized aqueous liquid into the spread dry particulate material comprises spraying the leachate into the spread dry particulate material.

15. The process according to claim 14, wherein the step of directing the hydrated particulate material to the depository comprises directing a stream of the hydrated particulate material into the landfill from which the leachate was collected.

16. The process according to claim 15, wherein the step of spreading the stream of dry particulate material comprises directing the dry particulate toward the apex of a conical spreader.

17. The process according to claim 13, wherein the step of spraying a pressurized aqueous liquid comprises directing the liquid, in as substantially horizontal spray, towards the particulate material after the material is spread.

18. The process according to claim 13, wherein delivering a pressurized stream of dry particulate material comprises delivering the particulate material at a pressure of between about 10 psi and about 20 psi.

19. The process according to claim 18, wherein the particulate matter is delivered at a pressure of about 15 psi.

20. The process according to claim 13, further comprising adjusting pressure of the aqueous liquid to control a degree of hydration of the hydrated particulate material.

21. The process according to claim 13, wherein the particulate matter is fly ash.

22. A process for hydrating a particulate material, comprising:
collecting landfill leachate from a landfill,
spraying the leachate into a spread dry particulate material such that the particulate material is hydrated with the leachate; and
directing the hydrated particulate material to a depository.
